(19) United States
(12) Patent Application Publication
(10) Pub. No.: US 2020/0247208 A1
(43) Pub. Date: Aug. 6, 2020

(54) ADVANCED DRIVER ASSISTANCE SYSTEM

(71) Applicant: DRiV Automotive Inc., Lake Forest, IL (US)

(72) Inventor: Brian A. Kunkel, Dexter, MI (US)

(21) Appl. No.: 16/777,873

(22) Filed: Jan. 30, 2020

Related U.S. Application Data
(60) Provisional application No. 62/800,772, filed on Feb. 4, 2019.

(51) Int. Cl. B60G 17/0165

(52) U.S. Cl. CPC B60G 17/0165; B60R 21/34; B60G 2400/823; B60G 2500/30

(57) ABSTRACT

A ride height control system for a vehicle includes a damper system configured to selectively adjust a ride height of the vehicle. The ride height control system includes a computer in communication with the damper system, the computer having a processor and a memory storing instructions executable by the processor to adjust the ride height of the vehicle upon determining that the vehicle will collide with a detected object.

### CROSS-REFERENCE TO RELATED APPLICATIONS

The subject patent application claims priority to, and all the benefits of, U.S. Provisional Patent Application No. 62/800,772 filed on Feb. 4, 2019, which is herein incorporated by reference in its entirety.

### FIELD

The present disclosure relates to systems and methods for adjusting suspension systems in vehicles.

### BACKGROUND

An automotive suspension system for a vehicle may include one or more adjustable components. For example, shock absorbers may be used in conjunction with a damper system in automotive or other suspension systems to absorb unwanted vibrations that occur during movement of the suspension system. In order to absorb these unwanted vibrations, automotive shock absorbers are generally connected between the sprung (body) and the unsprung (suspension/drivetrain) masses of the vehicle. In some examples, the damper system may be configured to vary a ride height at respective corners of the vehicle and/or an overall ride height of the vehicle.

### BRIEF DESCRIPTION OF THE DRAWINGS

The present disclosure will become more fully understood from the detailed description and the accompanying drawings, wherein:

FIG. 1 is perspective view of a vehicle having a ride height control system.

FIG. 2 is a block diagram illustrating components of the vehicle of FIG. 1.

FIG. 3 is a block diagram illustrating components of the vehicle of FIG. 1.

FIG. 4 is a block diagram illustrating components of the vehicle of FIG. 1.

FIG. 5 is a block diagram illustrating components of the vehicle of FIG. 1.

FIG. 6 is a block diagram illustrating components of a computer of the ride height control system of FIG. 1.

FIG. 7 is a side view of the vehicle of FIG. 1.

FIG. 8 is a flow chart illustrating a process for the ride height control system.

### DETAILED DESCRIPTION

A ride height control system for a vehicle includes a damper system configured to selectively adjust a ride height of the vehicle. The ride height control system includes a computer in communication with the damper system, the computer having a processor and a memory storing instructions executable by the processor to adjust the ride height of the vehicle upon determining that the vehicle will collide with a detected object.

The instructions may include instructions to identify the detected object as extending upwards from a road surface.

The instructions may include instructions to adjust the ride height to a height greater than a height of the object.

The instructions may include instructions to identify the detected object extending downwards from a road surface.

The instructions may include instructions to adjust the ride height to a height greater than a depth of the object.

The damper system may include a damper having an adjustable length.

Adjusting the ride height of the vehicle may include changing the length of the damper.

The damper system may include a damper and an actuator, and adjusting the ride height of the vehicle may include changing a length of the damper using the actuator.

The instructions may include instructions to identify the detected object as a second vehicle.

The instructions may include instructions to identify a characteristic of the second vehicle and to adjust the ride height of the vehicle based on the characteristic of the second vehicle.

The characteristic of the second vehicle may be a ride height of the second vehicle.

The instructions may include instructions to adjust the ride height of the vehicle to match the ride height of the second vehicle.

The characteristic of the second vehicle may be a position of the second vehicle relative to the vehicle.

The instructions may include instructions to identify a ride height of the second vehicle and a position of the second vehicle relative to the vehicle, and to adjust the ride height of the vehicle based on the ride height of the second vehicle and the position of the second vehicle.

The instructions may include instructions to identify the detected object as a pedestrian.

The instructions may include instructions to, upon identifying the detected object as a pedestrian, adjust the ride height to a predetermined height.

A system includes a computer having a processor and a memory storing instructions executable by the processor to adjust a ride height of a vehicle upon determining that the vehicle will collide with a detected object.

The instructions may include instructions to control an actuator of a damper system to adjust the ride height of the vehicle.

The instructions may include instructions to identify the detected object as one of extending upwards or downwards from a road surface, and to adjust the ride height to a height or a depth that is greater than a height or depth of the object.

The instructions may include instructions to identify the detected object as a second vehicle, to identify a characteristic of the second vehicle, and to adjust the ride height of the vehicle based on the characteristic of the second vehicle.

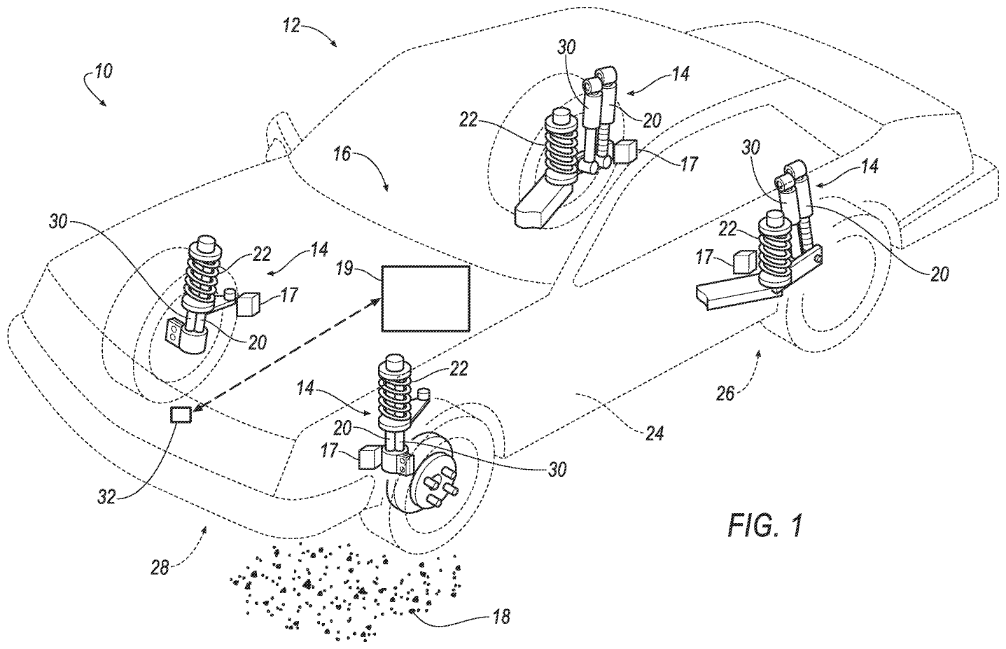

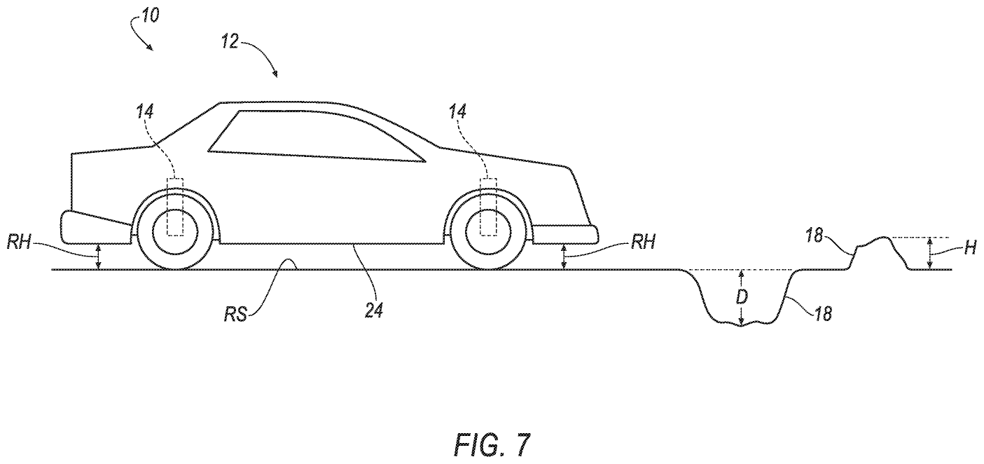

With reference to FIGS. 1-7, a ride height control system 10 for a vehicle 12 includes a damper system 14 configured to selectively adjust a ride height RH of the vehicle 12. The ride height control system 10 includes a computer 16 in communication with the damper system 14. The computer 16 has a processor and a memory storing instructions executable by the processor to adjust the ride height RH of the vehicle 12 based on a determination that the vehicle 12 will collide with a detected object 18.

Adjusting the ride height RH of the vehicle 12 in anticipation of the collision may limit and/or mitigate damage to the vehicle 12. For example, damage from road hazards such as potholes may be mitigated by raising the ride height RH of the vehicle 12.

The vehicle 12 may be any type of passenger or commercial automobile such as a car, a truck, a sport utility vehicle, a crossover vehicle, a van, a minivan, a taxi, a bus, etc.

The vehicle 12 includes a body 24 and a frame. The body 24 and frame may be of a unibody construction. In the unibody construction, the body 24, e.g., rockers, serves as the vehicle frame, and the body 24 (including the rockers, pillars, roof rails, etc.) is unitary, i.e., a continuous one-piece unit. As another example, the body 24 and frame may have a body-on-frame construction (also referred to as a cab-on-frame construction). In other words, the body 24 and frame are separate components, i.e., are modular, and the body 24 is supported on and affixed to the frame. Alternatively, the body 24 and frame may have any suitable construction. The body 24 and/or the frame may be formed of any suitable material, for example, steel, aluminum, etc.

The ride height RH is a vertical distance between a road surface RS supporting the vehicle and a bottom of the body 24 and/or frame of the vehicle 12. The vehicle 12 may have a different ride height RH at each of the wheels.

The vehicle 12 may include a suspension system for controlling movement of a body 24 of the vehicle 12 relative to wheels of the vehicle 12, e.g., including a rear suspension 26 at a rear of the vehicle 12 and a front suspension 28 at a front of the vehicle 12. The rear suspension 26 may include a transversely extending rear axle assembly (not shown) adapted to operatively support the rear wheels of the vehicle 12. The rear axle assembly may be operatively connected to the body 24 by two damper systems 14. The front suspension 28 may include a transversely extending front axle assembly (not shown) to operatively support the front wheels of the vehicle 12. The front axle assembly may be operatively connected to the body 24 by another two damper systems 14. The term “damper system” as used herein refers to spring/damper systems in general and thus includes, for example, MacPherson struts, independent front suspension systems, and/or independent rear suspension systems.

Each of the damper systems 14 may include a damper 20 and a spring 22, e.g., a helical coil spring. The dampers 20 may be arranged within the springs 22, e.g., in a coil-over arrangement. The dampers 20 may be spaced apart from the springs 22. The dampers 20 serve to dampen the relative motion of the unsprung portion of the front suspension 28 and rear suspension 26 and the sprung portion (i.e., the body 24) of the vehicle 12 by applying a damping force to the vehicle 12 that opposes the relative motion of the unsprung portion of the front suspension 28 and rear suspension 26 and the sprung portion (i.e., the body 24) of the vehicle 12. The springs 22 apply a biasing force to the sprung portion (i.e., the body 24) of the vehicle 12, which supports the sprung portion (i.e., the body 24) of the vehicle 12 on the unsprung portion of the front suspension 28 and rear suspension 26 in such a manner that bumps and other impacts are absorbed by the front suspension 28 and rear suspension 26.

Each damper 20 has an adjustable length, i.e., a distance between ends of the damper 20 may be increased or decreased. The damper 20 may adjust length in response to a command from the computer 16. For example, each damper system 14 may include an actuator 30 controlled by the computer 16. The actuators 30 may be positioned within, next to, or near the dampers 20. For example, the actuator 30 and the damper 20 may be arranged within the respective spring 22, e.g., in the coil-over arrangement. As another example, the damper 20 and the actuator 30 may be spaced apart from the spring 22. Different arrangements are possible, including arrangements where the same or similar damper systems 14 are used at all four wheels (or corners) of the vehicle 12.

When activated, e.g., by the computer 16, the actuators 30 apply an active force to soften or firm up the front suspension 28 and/or the rear suspension 26. For example, the actuators 30 may be activated depending on driver inputs, speed of the vehicle 12, road conditions, acceleration of the vehicle 12, etc. Generally, the force applied by the actuator 30 operates in a substantially parallel direction to the biasing force of the springs 22. For example, during turning the actuators 30 of the damper systems 14 on an outside of the turn may be activated to apply an active force to body 24 of the vehicle 12 to help keep the body 24 level during the turn. The actuators 30 may actively control movements of the body 24 of the vehicle 12 independently of the damping forces generated by the dampers 20. In other words, the actuators 30 operate in parallel with the dampers 20 to control the ride and handling of the vehicle 12. The actuators 30 may be linear actuators that increase (by extending) or decrease (by compressing) a distance between ends in response to an instruction from the computer 16. The actuator 30 may be, for example, a pneumatic actuator, a piezoelectric actuator, and/or an electromechanical actuator. The actuator 30 may convert rotary motion of an electric motor into linear displacement via screws and/or gears, e.g., with leadscrews, screw jacks, ball screws, roller screws, etc. The actuator 30 may utilize hydraulic pressure to move a piston disposed within a hollow cylinder filled with an incompressible fluid. Pressure may be provided to the fluid with a pump. Similarly, the actuator 30 may utilize pneumatic pressure. Conventional linear actuators may be used.

Each damper system 14 may be configured to selectively adjust the ride height RH of the vehicle 12. For example, the actuators 30 may independently vary the ride height RH at each corner of the vehicle 12, e.g., in response to a command from the computer 16. For example, the command from the computer 16 may specify a length for a specified actuator, e.g., a specific height for the front right actuator. The command may be sent to the respective actuator 30 to achieve the specified length and control the ride height RH at the respective corner.

The vehicle 12 includes sensors 32. The sensors 32 may detect internal states of the vehicle 12, for example, wheel speed, wheel orientation, and engine and transmission variables. The sensors 32 may detect the position or orientation of the vehicle 12, for example, global positioning system (GPS) sensors; accelerometers such as piezo-electric or microelectromechanical systems (MEMS) sensors; gyroscopes such as rate, ring laser, or fiber-optic gyroscopes; inertial measurements units (IMU); and magnetometers. The sensors 32 may detect the external world, for example, radar sensors, scanning laser range finders, light detection and ranging (LIDAR) devices, and image processing sensors such as cameras. The sensors 32 may include communications devices, for example, vehicle-to-infrastructure (V2I) or vehicle-to-vehicle (V2V) devices.

The sensors 32 may be supported at one or more positions in or on the body 24 of the vehicle 12. The sensors 32 may be configured to detect objects 18 including, but not limited to, other vehicles, road hazards (e.g., debris, potholes, etc.), pedestrians and cyclists, curbs or other road infrastructure, etc. For example, a plurality of sensors 32 may be arranged on a front and rear portion of the vehicle 12 to scan the environment (e.g., the road) in front of and/or behind the vehicle 12, respectively, and may be arranged on sides of the vehicle 12 to scan the environment next to the vehicle 12.

The vehicle 12 may include a navigation system 34. The navigation system 34 is implemented via circuits, chips, or other electronic components that can determine a present location of the vehicle 12. The navigation system 34 may be implemented via satellite-based system such as the Global Positioning System (GPS). The navigation system 34 may triangulate the location of the vehicle 12 based on signals received from various satellites in the Earth's orbit. The navigation system 34 is programmed to output signals representing the present location of the vehicle 12 to, e.g., the computer 16 via a communication network 36. In some instances, the navigation system 34 is programmed to determine a route from the present location to a future location, including developing alternative routes if a road is flooded. The navigation system 34 may access a virtual map stored in the memory (discussed below) and develop the route according to the virtual map data.

The communication network 36 includes hardware, such as a communication bus, for facilitating communication among components of the vehicle 12. The communication network 36 facilitates wired or wireless communication among the components, e.g., damper systems 14, the computer 16, the sensors 32, etc., in accordance with a number of communication protocols such as controller area network (CAN), Ethernet, WiFi, Local Interconnect Network (LIN), and/or other wired or wireless mechanisms.

The computer 16, implemented via circuits, chips, or other electronic components, is included for carrying out various operations, including as described herein. The computer 16 is a computing device that generally includes a processor and a memory, the memory including one or more forms of computer-readable media, and storing instructions executable by the processor for performing various operations, including as disclosed herein. The memory of the computer 16 further generally stores remote data received via various communications mechanisms; e.g., the computer 16 is generally configured for communications on a controller area network (CAN) bus or the like, and/or for using other wired or wireless protocols, e.g., Bluetooth, etc. The computer 16 may also have a connection to an onboard diagnostics connector (OBD-II). Via the communication network 36 using Ethernet, WiFi, the CAN bus, Local Interconnect Network (LIN), and/or other wired or wireless mechanisms, the computer 16 may transmit messages to various devices in the vehicle 12 and/or receive messages from the various devices, e.g., the sensors 32, the damper systems 14, etc.

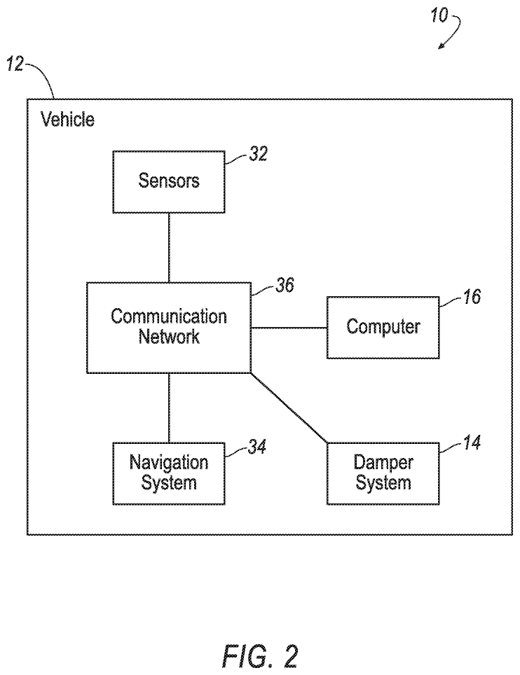

Although one computer 16 is shown in FIG. 2 for ease of illustration, it is to be understood that the computer 16 could include, and various operations described herein could be carried out by, one or more computing devices. For example, the computer 16 may include multiple computing devices.

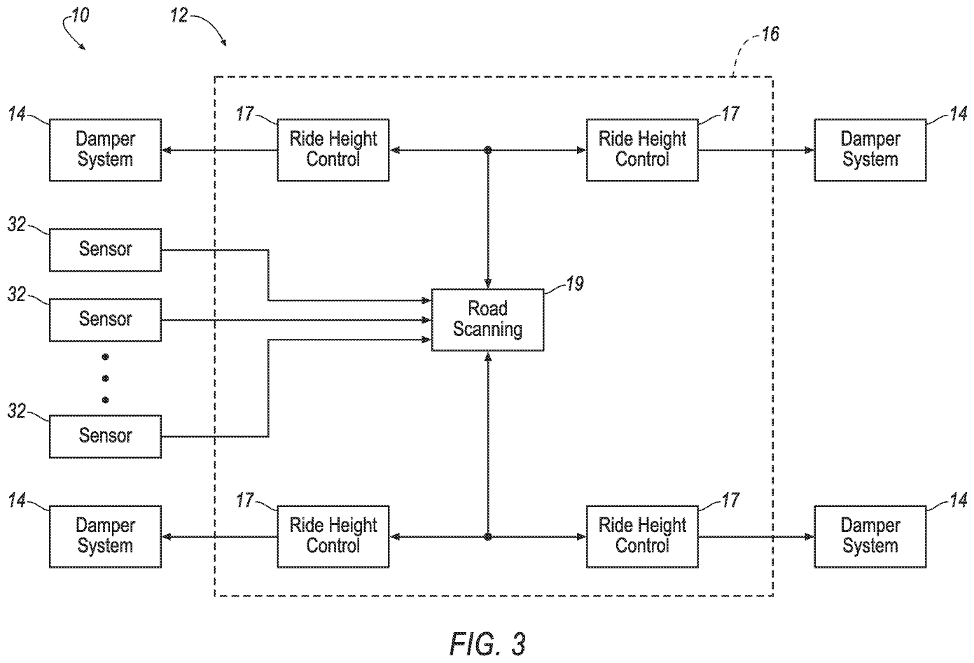

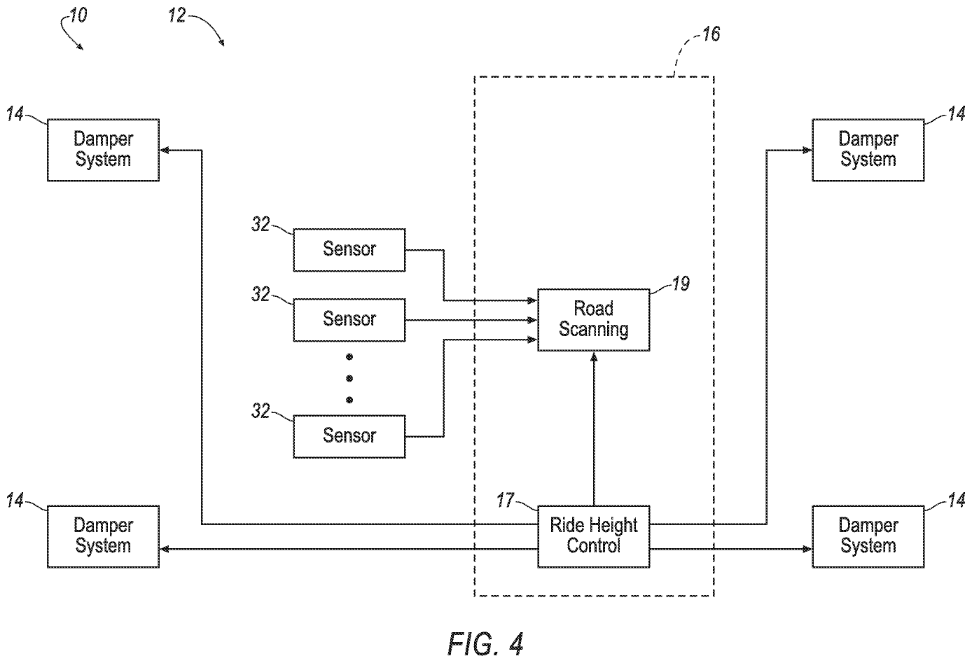

The computer 16 may include computing devices 17 that command the damper systems 20 and control ride height. Each computing device 17 may be associated with a specific wheel, e.g., computing devices 17 associated with the front wheels, respectively, and computing devices 17 associated with the rear wheels 18, respectively, as illustrated in FIGS. 1 and 3. Alternately, a single computing device 17 may be configured to interface with each of the damper systems 14, as illustrated in FIG. 4.

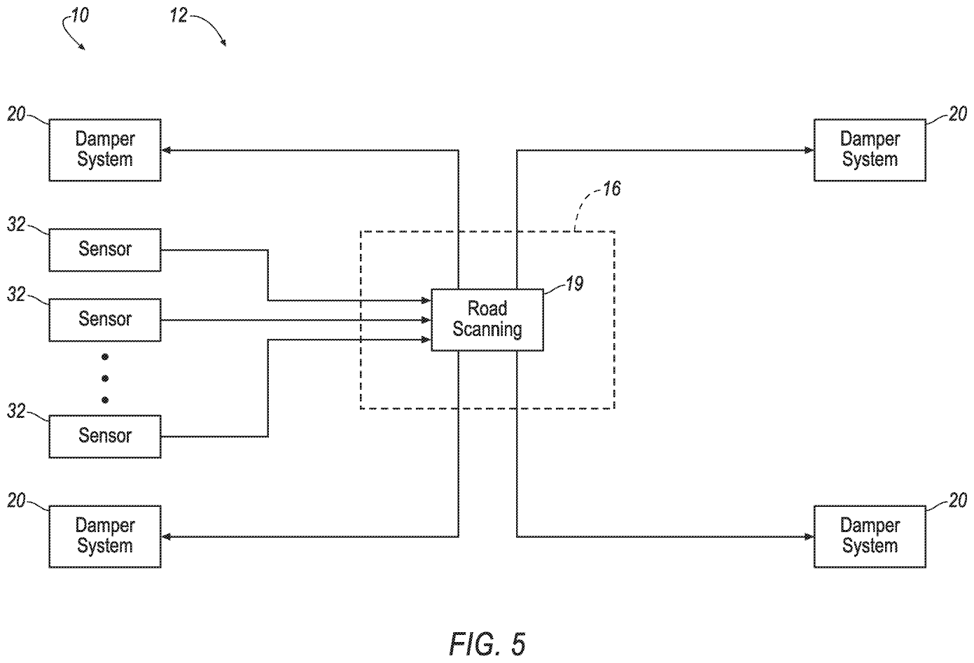

The computer 16 may include a computing device 19 that performs road scanning system and receives respective signals from one or more sensors 32 arranged to image and/or scan the surroundings of the vehicle 12. Accordingly, the signals received by the computing device 19 may indicate objects around and/or in the path of the vehicle 12. The computing device 19 may communicate with the computing device(s) 17, as illustrated in FIGS. 3 and 4. Alternately, the computing device 19 may command the damper systems 20 and control ride height, with the damper systems 20 responsive to signals from the computing device 19, as illustrated in FIG. 5.

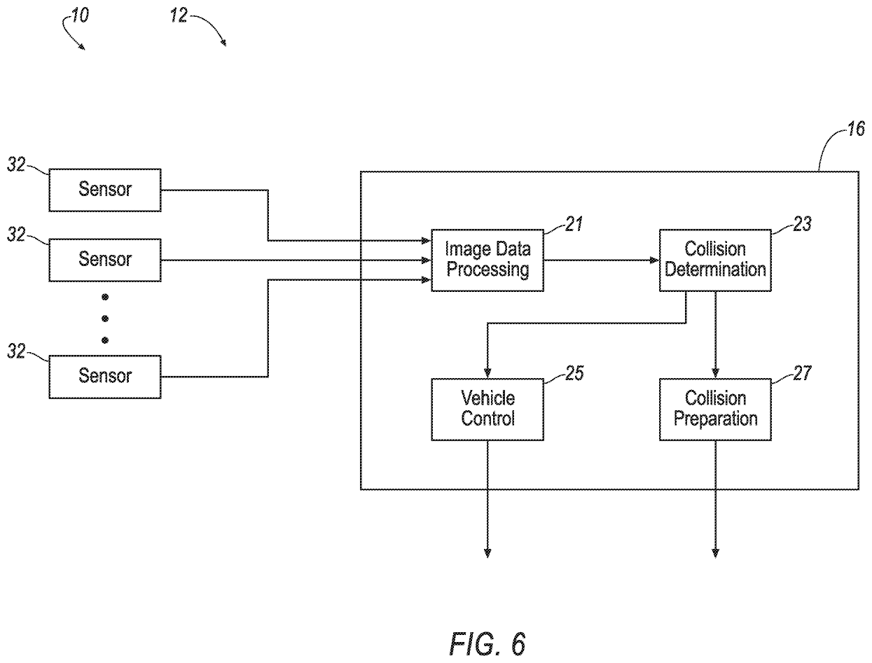

With reference to FIG. 6, the computer 16 may include a computing device 21 configured to receive signals from respective sensors 32. The signals may correspond to raw image data captured by the sensors 32. The computing device 21 processes the image data to form images of the environment surrounding the vehicle 12. For example, the computing device 21 analyzes the image data to detect objects in the environment, identify characteristics of the objects (e.g., location and velocity relative to the vehicle 12, size, shape, type, etc. The identified type of object may include, but is not limited to, a vehicle, a pedestrian or cyclist, a road hazard, etc. The analyzed image data may also indicate a direction of the object (e.g., whether the object is in front of the vehicle 12, approaching from a side or the rear of the vehicle 12, etc.) in accordance with the source of the image data (i.e., which of the sensors 32 provided the image data).

The computer 16 may include a computing device 23 that receives the analyzed image data including any identified objects and the direction of the object and determines whether a collision can be avoided. For example, in non-autonomous vehicles, the computing device 23 may determine whether a collision with an object in front of the vehicle 12 is unavoidable based on driver inputs, a distance between the object and the vehicle 12, a speed and acceleration (positive or negative) of the vehicle 12, etc.). In other words, if driver inputs indicate that the vehicle 12 is braking and/or swerving, the computing device 23 may determine that the driver is reacting sufficiently and a collision may be avoided. Conversely, if driver inputs indicate that the driver is not attempting to avoid the collision and/or the driver's actions will not be sufficient to avoid the collision (e.g., based on a distance to the object and the acceleration and trajectory of the vehicle), the computing device 23 may determine that the collision is unavoidable.

In examples where the vehicle 12 is autonomous or semi-autonomous, the computing device 23 may determine whether a collision with the object unavoidable based on driver inputs, a distance between the object and the vehicle 12, a speed and acceleration (positive or negative) of the vehicle 12, etc.), and further based on autonomous vehicle capabilities. For example, the computer 16 may include a computing device 25 configured to automatically control the vehicle 12 (i.e., to steer, brake, etc. without or in addition to driver inputs) to avoid collisions in response to image or sensor data. The computing device 23 may nonetheless determine that a collision is unavoidable based on the image data despite intervention by the computing device 25.

In examples where an object such as another vehicle is approaching the vehicle 12 from a side or the rear, the computing device 23 may determine whether a collision with the object is unavoidable based on driver inputs, a distance between the object and the vehicle 12, a speed and acceleration (positive or negative) of the vehicle 12 and the approaching object, etc.). In these examples, driver input may not be sufficient to avoid a collision. Accordingly, when the object is another vehicle approaching from a side or rear of the vehicle 12, the computing device 23 may determine that a collision is unavoidable even if there is still opportunity for the other vehicle to stop or change trajectory.

The computer 16 may include a computing device 27 that receives a signal indicating whether a collision is unavoidable from the computing device 23 and prepares the vehicle 12 (e.g., outputs control signals to the damper systems 20 to adjust the ride height of the vehicle 12) accordingly. For example, in addition to the determination that the collision is unavoidable, the signal may include additional data indicating characteristics of the object, a direction of the object, etc. In this manner, the computing device 27 may adjust the ride height in accordance with the predicted collision.

For example, if the object is taller (e.g., a vehicle having a taller bumper) than the vehicle 12, the computing device 27 may increase the height of the vehicle 12. For example, the computing device 27 may increase the height of the vehicle 12 to match a height of the object (e.g., to align a bumper of the vehicle 12 to the other vehicle), to maximize contact between the bumper of the vehicle 12 and a detected object, etc. Conversely, if the object is lower (e.g., a vehicle having a lower bumper) than the vehicle 12, the computing device 27 may decrease the height of the vehicle 12. In this manner, a contact area with structural components of the vehicle 12 designed to absorb impacts is maximized and collisions where one vehicle passes above or beneath another vehicle or object may be mitigated. In some examples, the computing device 27 may adjust the height of the vehicle 12 only on a side of the vehicle 12 of the predicted collision with the detected object.

Similarly, the computing device 27 may adjust the height of the vehicle 12 in response to a determination that a wheel of the vehicle 12 will cross over a pothole, crack, or other road hazard that could damage the vehicle. For example, the computing device 27 may control the damper system 20 to raise a corner of the vehicle 12 corresponding to the wheel entering a pothole to prevent an impact between the underside of the vehicle 12 and an edge of the pothole.

In still other examples (e.g., where the detected object is a pedestrian or cyclist), the computing device 27 may be configured to disable or override any adjustment to the ride height of the vehicle 12. In other words, since adjusting the ride height of the vehicle 12 may not be desirable in some types of collisions, the collision computing device 27 may selectively prevent an adjustment to the ride hide based on an identified type of the object in the predicted collision.

The computer 16 is be programmed to, i.e., the memory stores instructions executable by the processor to, identify objects 18 detected by the sensors 32. The computer 16 may identify characteristics of the objects 18 detected by the sensors 32. For example, the computer 16 may identify the detected object 18 as extending downwards from the road surface RS (e.g., a pothole), as extending upwards from the road surface RS (e.g., a speed bump or curb), a location and/or velocity relative to the vehicle 12, a size of the detected object 18, a shape for the detected object 18, etc. As another example, the computer 16 may identify a depth D below, or height H above, the road surface RS (e.g., a depth of a pothole, a height of a curb or bumper), etc. The computer may identify a type of the object 18 detected by the sensors 32. For example, the computer 16 may identify the type of the detected object 18 as a second vehicle, a pedestrian, a cyclist, a road hazard, an obstacle or obstruction, etc. The computer 16 may identify the type and/or characteristics of the object 18 based on image data from one or more cameras, e.g., using conventional image recognition techniques. The computer 16 may identify the object 18 and characteristics of the object 18 based on data from a LIDAR sensor, e.g., using conventional techniques for processing point cloud data. For example, the computer 16 may process the image data, LIDAR data, and/or other sensor data to form images and/or other digital representations of the environment surrounding the vehicle 12. Other techniques may be used to identify the object 18 and characteristics of the object 18 based on data from one or more sensors 32.

The computer 16 may be programmed to determine whether the detected object 18 is approaching the vehicle 12. The computer 16 may determine whether the detected object 18 is approaching the vehicle 12 based on data from the sensors 32. The computer 16 may determine whether the detected object 18 is approaching the vehicle 12 by identifying a distance of the detected object 18 from the vehicle 12 over time. The computer 16 may determine the detected object 18 is approaching the vehicle 12 upon identifying that the distance between the detected object 18 and the vehicle 12 decreases over time. The computer 16 may identify the distance between the detected and the object 18 and the vehicle 12 based on data from the sensors 32, e.g., range data from LIDAR, radar, and/or sonar sensors 32; binocular analysis of image data from a pair of cameras (e.g., ranging imaging using stereo camera images); etc. The computer 16 may identify the distance between the detected object 18 and the vehicle 12 based on data from the sensors 32 using conventional techniques.

The computer 16 may determine a position (e.g., direction) of the detected object 18 relative to the vehicle 12, e.g., whether the detected object 18 is approaching from a front, a rear, or a side, of the vehicle 12. The computer 16 may determine the position of the detected object 18 based on data from the sensors 32. For example, analyzed image data, LIDAR data, etc., may indicate a direction of the detected object 18 from the vehicle 12. The computer 16 may determine the direction of the detected object 18 using conventional techniques.

The computer 16 may be programmed to determine whether the detected object 18 is in a predicted path of the vehicle 12. The vehicle 12 may identify a predicted path of the vehicle 12 based on data from the sensors 32 and/or the navigation system 34. For example, the computer 16 may identify the predicted path using autonomous/semiautonomous conventional route planning, path planning and/or obstacle avoidance. As another example, the computer 16 may identify the predicted path based on data indicating driver input (such as steering wheel, accelerator pedal, and brake pedal input). The computer 16 may use conventional techniques to identify the predicted path. The computer 16 may determine the detected object 18 is in the predicted path when the detected position (or predicted future position) of the detected object 18 overlaps the predicted path, e.g., spatially. The predicted future position of the detected object 18 may be identified, for example, via extrapolation of the position of the detected object 18 over time. The computer 16 may used conventional techniques to determine whether the detected object 18 is in the predicted path of the vehicle 12 and/or or to predict the future position of the detected object 18.

The computer 16 may be programmed to determine whether the vehicle 12 will collide with the detected object 18. The computer 16 may determine whether the vehicle 12 will collide with the object 18 based on data from the sensors 32, e.g., preimpact sensing. For example, the vehicle 12 may be unable to stop, swerve out of the path of, or otherwise avoid another vehicle or obstacle in front of the vehicle 12 (e.g. a vehicle suddenly swerving or driving into the path of the vehicle 12, stopping abruptly due to a collision, etc.). In another example, a second vehicle may be detected approaching from a side or rear of the vehicle 12 (e.g., at a speed or trajectory that makes a collision with the vehicle 12 unavoidable).

The computer 16 may determine whether the vehicle 12 will collide with the object 18 based on driver input (or lack thereof), e.g., input to a steering wheel, accelerator pedal, or brake pedal. The computer 16 may determine whether the driver input is sufficient to avoid colliding with the detected object 18. The computer 16 may further determine whether the vehicle 12 will collide with the object 18 based on a distance between the object 18 and the vehicle 12, a speed and acceleration (positive or negative) of the vehicle 12, etc. For example, if driver inputs indicate that the vehicle 12 is braking and/or swerving, the computer 16 may determine that the driver is reacting sufficiently and a collision may be avoided. Conversely, if driver inputs indicate that the driver is not attempting to avoid the collision and/or the driver's actions will not be sufficient to avoid the collision (e.g., based on a distance to the object 18 and the acceleration and trajectory of the vehicle 12 and object 18, etc.), the computer 16 may determine that the collision is unavoidable. The computer 16 may determine the detected object 18 will collide the vehicle 12 using conventional techniques.

The computer 16 is programmed to adjust the ride height RH of the vehicle 12. Adjusting the ride height RH of the vehicle 12 includes changing the length of one or more of the dampers 20, e.g., using the actuator(s) 30. For example, the computer 16 may transmit a command to the actuator 30 via the communication network 36. The command may specify a length. The computer 16 may selectively adjust the ride height RH of the vehicle 12 to prepare for the collision with the detected object 18. For example, the computer 16 may independently raise or lower portions of the vehicle 12 (such as raising just the front). Adjusting the ride height RH of the vehicle 12 in anticipation of the collision may limit and/or mitigate damage to the vehicle 12.

The computer 16 may adjust the ride height RH of the vehicle 12 based on the characteristics and/or type of the detected object 18. The computer 16 may adjust the ride height RH to predetermined heights and/or positions associated with the characteristics and/or types. For example, a lookup table or the like may be stored in memory of the computer 16. The lookup table may associate various characteristics and/or types of the detected objects 18 with heights, e.g., as shown in the example Table 1 below:

TABLE 1

| Type | Characteristic(s) | Ride Height |
|---|---|---|
| Pedestrian | At front of vehicle | Predetermined ride height at |
| | | front of vehicle based on |
| | | pedestrian impact testing |
| Second Vehicle | At left side of vehicle | Ride height left side of |
| | | vehicle to match ride |
| | | height of second vehicle |
| Pothole | Having a depth and at | Ride height greater than |
| | front of vehicle | depth of the pothole |
| Curb | Having a height and at | Ride height greater than |
| | front of vehicle | height of the curb |

The computer 16 may adjust the ride height RH to a height greater than a height H of the detected object 18, e.g., to avoid collision between the detected object 18 and the body 24 of the vehicle 12. For example, the computer 16 may identify a height of a curb detected by the sensors 32, and may command one or more of the actuators 30 to a length that provides a ride height RH that is greater that the height of the curb and avoids collision of the body 24 of the vehicle 12 with the curb.

The computer 16 may adjust the ride height RH to a height greater than a depth D of the object 18 below a road surface RS, e.g., to prevent the vehicle 12 from “bottoming out.” For example, the computer 16 may identify a depth of a pothole detected by the sensors 32, and may command one or more of the actuators 30 to a length that provides a ride height RH that is greater than the depth of the pothole and avoids collision of the body 24 of the vehicle 12 with the road surface RS proximate the pothole.

The computer 16 may refrain from adjusting the ride height RH of the vehicle 12 based on the height H or depth D of the detected object 18 when the present ride height RH of the vehicle 12 is greater than the depth D or height H of the detected object 18. The computer 16 may identify the present ride height RH based on data from the sensors 32, e.g., sensors 32 that detect positions of components of the suspension system that indicate the ride height RH, e.g., a position of a swing arm relative to the frame and/or body 24, a length of a damper 20, etc. The computer 16 may detect the ride height RH with conventional techniques. The computer 16 may determine when the present ride height RH of the vehicle 12 is greater than the depth D or height H of the detected object 18 by comparing the present ride height RH with the depth D or height H of the detected object 18.

The computer 16 may adjust the ride height RH the vehicle 12 to maximize contact area between a bumper of the vehicle 12 and the detected object 18, etc. The computer 16 may adjust the ride height RH of the vehicle 12 to maximize contact area between the bumper of the vehicle 12 and the detected object 18 when the height H or depth D of the detected object 18 is greater than a maxim ride height that the damper systems 14 may provide. In this manner, a contact area with structural components of the vehicle 12 designed to absorb impacts is maximized. For example, the computer 16 may adjust the ride height RH of the vehicle 12 to match the height H of the detected object 18.

The computer 16 may adjust the ride height RH of the vehicle 12 based on an identified ride height of the second vehicle. In such situation, the computer 16 may adjust the ride height RH of the vehicle 12 to match the ride height RH of the second vehicle, i.e., such that the second vehicle does not overrun or underrun the vehicle 12 when the vehicle 12 and the second vehicle collide.

The computer 16 may adjust the ride height RH of the vehicle 12 based a position of the second vehicle relative to the vehicle 12. For example, the computer 16 may adjust the ride height RH to a first height when the second vehicle is to the side of the vehicle 12 and to a second height that is different than the first height when the second vehicle is to the front of the vehicle 12. The first and second heights may be predetermined based on real world test and/or computer modeling that analyzes effects of collisions to the front and sides of the vehicle 12 at different ride heights RH.

The computer 16 may adjust the ride height RH of the vehicle 12 based on a ride height of the second vehicle and the position of the second vehicle For example, when the second vehicle is to the front of the vehicle 12, the computer 16 may adjust the ride height RH of the vehicle 12 such that a height of a front bumper of the vehicle 12 is substantially the same as a height of an identified bumper of the second vehicle, i.e., such that the bumpers of the vehicle 12 and the second vehicle impact each other when the vehicle 12 and the second vehicle collide. As another example, when the second vehicle is to the side of the vehicle 12, the computer 16 may adjust the ride height RH of the vehicle 12 such that a height of a rocker rail, a side door impact beam, or other suitable support structure of the vehicle 12 is substantially the same as the height of the identified bumper of the second vehicle, i.e., such that the bumper of the second vehicle and the rocker rail, side door impact bear, etc., impact each other when the vehicle 12 and the second vehicle collide. The computer 16 may only adjust the ride height RH at the side of the vehicle 12 that will be impacted by the second vehicle. For example, when the second vehicle is to the right side of the vehicle 12, the computer 16 may adjust the ride height RH of the right side of the vehicle 12 and not the left side. As another example, when the second vehicle is to the left side of the vehicle 12, the computer 16 may adjust the ride height RH of the left side of the vehicle 12 and not the right side.

The computer 16 may adjust the ride height RH to a predetermined height upon identifying the detected object 18 as a pedestrian. The predetermined height may be based on real world testing (such as using a crash test dummy) and/or computer modeling that analyzes effects of collisions between the vehicle 12 and a pedestrian.

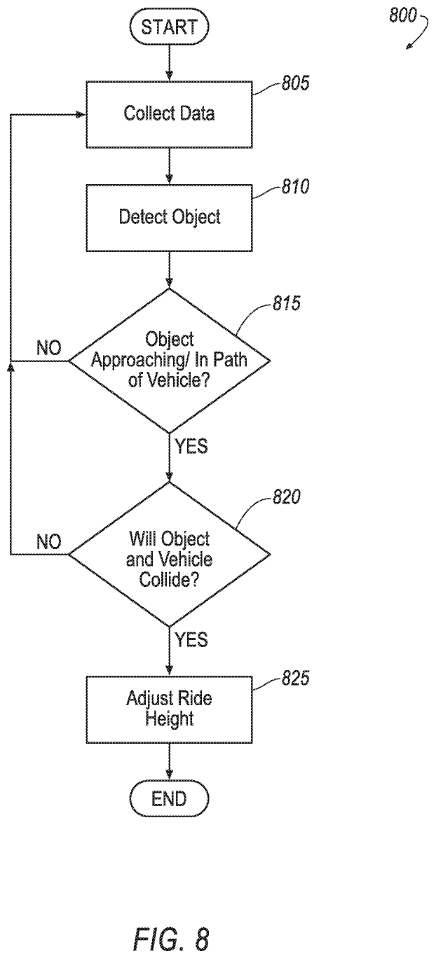

FIG. 8 is a process flow diagram illustrating an exemplary process 800 for controlling the ride height control system 10. The process 800 begins in a block 805 where the computer 16 receives data, e.g., from the sensors 32 via the communication network 36. The computer 16 may receive data substantially continuously or at intervals, e.g., every 100 milliseconds.

At a block 810 the computer 16 detects an object 18 in the data from the sensors 32. The computer 16 may additionally identify a type and/or characteristic of the detected object 18 based on the sensor 32 data received at the block 805. For example, the computer 16 may identify a height H or depth D of the detected object 18. As another example, the computer 16 may identify the object 18 as a second vehicle, a pedestrian, etc. As another example, the computer 16 may identify a ride height and/or a position of the detected second vehicle relative to the vehicle 12.

At a block 815 the computer 16 determines whether the detected object 18 is approaching the vehicle 12 and/or is in a path of the vehicle 12, e.g., as described herein. Upon determining the detected object 18 is approaching the vehicle 12 and/or is in the path of the vehicle 12, the process 800 moves to a block 820. Upon determining the detected object 18 is not approaching the vehicle 12 and is not in the path of the vehicle 12, the process 800 returns to the block 805.

At the block 820 the computer 16 determines whether the detected object 18 and the vehicle 12 will collide, e.g., as described herein. Upon determining the detected object 18 and the vehicle 12 will collide, the process 800 moves to a block 825. Upon determining the detected object 18 and the vehicle 12 will not collide, the process 800 returns to the block 805. Alternately, the process 800 may end.

At the block 825 the computer 16 selectively adjusts the ride height RH of the vehicle 12, e.g., by sending commands to one or more of the dampening systems (e.g., to actuator 30(s)) via the communication network 36. The computer 16 may adjust the ride height RH of the vehicle 12 based on the identified type and/or characteristic(s) of the detected object 18, data from the sensors 32, etc. For example, the computer 16 may selectively command the actuators 30 to specified lengths based on a height H or depth D of the detected object 18, to maximize contact area between the vehicle 12 and the detected object 18, upon identifying the detected object 18 as a second vehicle, based on a detected ride height of the detected second vehicle, based on a position of the detected second vehicle relative to the vehicle 12, upon identifying the detected object 18 as a pedestrian, etc.

With regard to the process 800 described herein, it should be understood that, although the steps of such process 800 have been described as occurring according to a certain ordered sequence, such process 800 could be practiced with the described steps performed in an order other than the order described herein. It further should be understood that certain steps could be performed simultaneously, that other steps could be added, or that certain steps described herein could be omitted. In other words, the description of the process 800 herein is provided for the purpose of illustrating certain embodiments and should in no way be construed so as to limit the disclosed subject matter.

Computing devices, such as the computer, generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In some examples, system elements may be implemented as computer-readable instructions (e.g., software) on one or more computing devices (e.g., servers, personal computers, computing modules, etc.), stored on computer readable media associated therewith (e.g., disks, memories, etc.). A computer program product may comprise such instructions stored on computer readable media for carrying out the functions described herein.

The terms “in response to” and “upon” herein specify a causal relationship in addition to a temporal relationship.

The adjectives “first,” “second,” “third,” etc., are used throughout this document as identifiers and are not intended to signify importance or order.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A ride height control system for a vehicle, the ride height control system comprising:
a damper system configured to selectively adjust a ride height of the vehicle; and
a computer in communication with the damper system, the computer having a processor and a memory storing instructions executable by the processor to adjust the ride height of the vehicle upon determining that the vehicle will collide with a detected object.

2. The ride height control system of claim 1, wherein the instructions include instructions to identify the detected object as extending upwards a height above a road surface.

3. The ride height control system of claim 2, wherein the instructions include instructions to adjust the ride height upwards to a height greater than the height of the object.

4. The ride height control system of claim 1, wherein the instructions include instructions to identify the detected object as extending downwards a depth below a road surface.

5. The ride height control system of claim 4, wherein the instructions include instructions to adjust the ride height upwards to a height greater than the depth of the object.

6. The ride height control system of claim 1, wherein the damper system includes a damper having an adjustable length.

7. The ride height control system of claim 6, wherein adjusting the ride height of the vehicle includes changing the length of the damper.

8. The ride height control system of claim 1, wherein the damper system includes a damper and an actuator, and wherein adjusting the ride height of the vehicle includes changing a length of the damper using the actuator.

9. The ride height control system of claim 1, wherein the instructions include instructions to identify the detected object as a second vehicle.

10. The ride height control system of claim 9, wherein the instructions include instructions to identify a characteristic of the second vehicle and to adjust the ride height of the vehicle based on the characteristic of the second vehicle.

11. The ride height control system of claim 10, wherein the characteristic of the second vehicle is a ride height of the second vehicle.

12. The ride height control system of claim 11, wherein in the instructions include instructions to adjust the ride height of the vehicle to match the ride height of the second vehicle.

13. The ride height control system of claim 10, wherein the characteristic of the second vehicle is a position of the second vehicle relative to the vehicle.

14. The ride height control system of claim 9, wherein the instructions include instructions to identify a ride height of the second vehicle and a position of the second vehicle relative to the vehicle, and to adjust the ride height of the vehicle based on the ride height of the second vehicle and the position of the second vehicle.

15. The ride height control system of claim 1, wherein the instructions include instructions to identify the detected object as a pedestrian.

16. The ride height control system of claim 15, wherein the instructions include instructions to, upon identifying the detected object as a pedestrian, adjust the ride height to a predetermined height.

17. A system, comprising a computer having a processor and a memory storing instructions executable by the processor to adjust a ride height of a vehicle upon determining that the vehicle will collide with a detected object.

18. The system of claim 17, wherein the instructions include instructions to control an actuator of a damper system to adjust the ride height of the vehicle.

19. The system of claim 17, wherein the instructions include instructions to identify the detected object as one of extending upwards or downwards from a road surface, and to adjust the ride height to a height or a depth that is greater than a height or depth of the object.

20. The system of claim 17, wherein the instructions include instructions to identify the detected object as a second vehicle, to identify a characteristic of the second vehicle, and to adjust the ride height of the vehicle based on the characteristic of the second vehicle.
